(19) United States
(12) Patent Application Publication
(10) Pub. No.: US 2006/0292410 A1
(43) Pub. Date: Dec. 28, 2006

(54) Fuel cell system for a vehicle

(76) Inventors: Andreas Kaupert, Esslingen (DE); Karsten Reiners, Esslingen (DE); Gunter Eberspach, Wolfschlugen (DE)

Correspondence Address: TAYLOR & AUST, P.C., 142 SOUTH MAIN STREET, P. O. BOX 560, AVILLA, IN, 46710, US

(21) Appl. No.: 11/475,514

(22) Filed: Jun. 27, 2006

(30) Foreign Application Priority Data
Jun. 28, 2005 (DE) 10 2005 030 474.5
May 4, 2006 (EP) EP06009180

(51) Int. Cl. H01M 8/06; H01M 8/10

(52) U.S. Cl. 429/20; 429/30; 429/17

(57) ABSTRACT

A fuel cell system for a vehicle including at least one reformer, at least one fuel cell and at least one reformer-reformate burner arrangement. The at least one reformer is configured for the production of a reformate as a fuel gas. The at least one fuel cell receives the reformate from the at least one reformer. The at least one reformer-reformate burner arrangement is connected to the fuel cell, where either prior to reaching an anti-condensation temperature of residual hydrocarbons and water vapor the combustion gases, which are produced in the reformer-reformate burner arrangement, are immediately directed into the fuel cell or after reaching the anti-condensation temperature the reformate is immediately directed into the fuel cell.

### BACKGROUND OF THE INVENTION

1. Field of the Invention

The present invention relates to a fuel cell system for vehicles.

2. Description of the Related Art

Due to the ever increasing power consumption in modern motor vehicles and because of the increasingly costly on-board electronics the requirement exists to replace the motor driven power generators with motor-independent power units. Such motor-independent power units are also referred to as Auxiliary Power Units (APU). Such motor-independent power generators are preferred that can be operated with the assistance of fuel cell units. The advantage of such systems is to be found in that fuel cells can be operated with conventional fuels. In order to generate power the conventional fuel such as gasoline or diesel fuel is first of all converted in a so-called reformer to a hydrogenous gas which is then, together with air converted to power in a fuel cell.

A system is known from German Patent DE 100 13 597 A1, which includes an internal combustion engine or a burner and a fuel cell. The hydrogen produced in a reformer from liquid fuel is separated from the residual fuel in a separator and is then directed to a fuel cell in order to produce electricity. The residual fuel, which was separated from the hydrogen, is possibly directed together with an additional fuel flow from the fuel source to a burner. The heat generated there can, for example, be utilized to create kinetic energy and reactants for the fuel cell process and the reformer process, as well as to pre-heat exhaust gas systems and interior spaces of a vehicle.

A cold start method for a reformer arrangement has become known from German Patent DE 101 42578 A1. However, no reformer-reformate burner is located after the reformer and before the fuel cell in the method which is known from German Patent DE 101 42578 A1.

In German Patent DE 10002006 A1 a reformer arrangement including a catalytic converter unit for a fuel cell system is disclosed whereby the catalytic converter is heated electrically in order to achieve the necessary operating temperature.

German Patent DE 199 13 794 A1 shows a system where a cooling medium circulates between a fuel cell, an internal combustion engine and a radiator, in order to release heat produced in the area of the fuel cell, as well heat produced as in the area of the internal combustion engine. The flow of exhaust gas leaving the internal combustion engine flows, for transfer of the heat that is transported there, from a heat exchanger into a reformer, prior to being discharged to the outside through an exhaust gas cleaning step.

German Patent DE 44 46 841 A1 discloses a fuel cell module whereby a hydrogenous fuel gas, after it has flowed through a fuel cell and electricity has been produced through reaction of hydrogen with oxygen, is directed through a burner in order to burn the residual hydrogen containing anodic exhaust gas in a catalytic reaction in the burner. The heat generated with this, and transported in the combustion exhaust gases, is transferred to the fuel cell in the cathode area.

A fuel cell system has become known from German Patent DE 10 2004 002337 A1 whereby a residual reform unit is connected with an afterburner as well as through a recycling heat exchanger with the reformer.

A heating system for a vehicle has become known through German Patent DE 102 44 803 B4 where a reformer arrangement, which, for example, provides hydrogen for the operation of a fuel cell, is coupled with a heating system. The coupling to the heating system occurs in that the hydrogen, which is provided by the reformer arrangement, is burned and the combustion heat thus generated is used to heat various vehicle system areas. Such an arrangement permits integration of the auxiliary heating or the additional heating function into a reformer system.

A disadvantage of the arrangement known from DE 102 44 883 is that a burner arrangement is located following the reformer, whereby the heat made available in the burner arrangement is provided to other components of the vehicle with the assistance of a heat exchanger arrangement. However, the heat released by the heat exchanger is basically only required in auxiliary or winter operation. If the heat is not required then the downstream heat exchanger represents a heat sink in the system. For the reasons mentioned above a downstream installation of a heat exchanger immediately after the former is very expensive and therefore disadvantageous. A recirculation of fuel cell exhaust gas is not taught in German Patent DE 10244883.

### SUMMARY OF THE INVENTION

It is the objective of the present invention to overcome the disadvantages of the state of the art. In particular, a fuel cell system is provided in accordance with one embodiment of the present invention, which can be started with the assistance of the reformer, whereby irreversible deposits of condensation residue, which are formed as a result of the composition of the reformate in the starting phase, that is at low temperatures are avoided. The deposit of condensation residue and also soot in the fuel cell during the starting phase of the reformer is explainable in that the reformer contains a considerable amount of gaseous water and incompletely converted hydrocarbon, which condense out in the components, following the reformer, for example, in the gas cleaning step and/or the fuel cell.

In particular, a solution of the present invention, which distinguishes itself through as simple and economical a construction as possible, as compared to the arrangement of German Patent DE 102 44 883 and is especially one which avoids the aforementioned disadvantage during the start procedure.

In accordance with another second aspect of the present invention a system is disclosed particularly for a fuel cell system that includes a Proton Exchange Membrane (PEM) fuel cell, which distinguishes itself through increased efficiency and a longer life span.

According to one embodiment of the present invention a fuel cell system at least one reformer configured for the production of a reformate as a fuel gas; at least one fuel cell to which the reformate from said at least one reformer is supplied; at least one reformer-reformate burner arrangement, said at least one reformer-reformate burner arrangement being connected to said fuel cell, where one of prior to reaching an anti-condensation temperature of residual hydrocarbons and water vapor the combustion gases which are produced in the reformer-reformate burner arrangement are immediately directed into the fuel cell and after reaching the anti-condensation temperature the reformate is immediately directed into the fuel cell (108, 208).

In addition to the device of the present invention there is also provided a method for starting a fuel cell system. This method includes the steps of starting the reformer one of electrically or thermally at an air ratio greater than 1; heating a catalytic converter of the reformer to a catalytic converter activation temperature; producing a reformate in the reformer after reaching said catalytic converter activation temperature at an air ratio less than 1, said reformate is then burned in the reformer-reformate burner arrangement at an air ratio greater than 1, whereby combustion gases are created; feeding said combustion gases to the fuel cell; interrupting the burning of the reformate in the reformer-reformate burner arrangement after reaching an anti-condensation temperature; feeding unburned reformate to the fuel cell and to a residual gas burner; and using said residual gas burner to burn the unburned component of anode exhaust gas at an air ratio greater than 1 and by way of a heat exchanger heat the air and/or water to heat the fuel cell to an operating temperature or the reactants air and/or water for the reformer.

The inventive fuel cell system in accordance with the one embodiment of the present invention includes a reformer-reformate burner arrangement connected directly with the fuel cell. The combustion gases which are produced in the reformer-reformate burner arrangement, prior to reaching an anti-condensation temperature the combustion gases or after reaching the anti-condensation temperature reformate, are immediately directed into the fuel cell.

The arrangement includes a reformer-reformate burner arrangement located downstream from the reformer that allows the method process described below, for starting the fuel cell system, to occur.

As a first step in starting the fuel cell system, the components for the mixture formation, that is the reformer and the air that is supplied to the reformer, are heated until the activation temperature of the catalytic converter, in other words the converter activation temperature has been reached. Preheating can occur either electrically, with the assistance of heating devices, or through the thermal heat impulse of a flame in the mixture formation chamber of the reformer at an air ratio or lambda greater than 1, or leaner than stoichiometric. The converter activation temperature is preferably in the range of 250° to 400° C., especially preferably at approximately 350° C. Once the converter activation temperature has been reached, through the preheating step described above, a fuel/air mixture or fuel/water/air mixture or fuel/water mixture which is supplied to the reformer is converted, resulting in a hydrogenous gas, which is also referred to as reformate in the following description. In a fuel/air mixture a low air ratio of preferably approximately 0.35 is used for the production of the reformate. As described above the fuel/air mixture is converted in the catalytic converter of the reformer into a hydrogenous gas at temperatures of approximately 950° Celsius.

At the low catalytic converter temperatures, when starting the reformer, the reformate, in addition to hydrogen, still contains a considerable amount of gaseous water and are not completely converted hydrocarbons.

In a second step of the present invention the reformate, or in other words the hydrogenous gas, is immediately burned at leaner than stoichiometric, or in other words at a lean mixture in the reformer-reformate burner arrangement. This creates combustion gases, which can be used to heat the reformer line and all other downstream components such as, for example, the fuel cell or gas cleaner. In contrast to German Patent DE 102 44 803 no heat exchanger downstream from the reformer-reformate burner arrangement is required. Instead the combustion gases are used immediately to heat other components. Accordingly, the present invention distinguishes itself through a simpler constructive solution than that specified in German Patent DE 102 44 803. Heating of the following components, for example, the fuel cell by way of a gaseous carrier flow instead of a heat transfer medium, as in the current state of the art, is possible because the reformate is burned in the start-up phase and therefore a condensation of hydrocarbons contained in the reformate during the start-up phase is avoided in the fuel cell. In addition soot formation, in other words deposits of soot on the cold walls, is greatly reduced with the inventive apparatus and method of the present invention.

After reaching the anti-condensation temperature of the products leaving the reformer, for example, in the fuel cell, the air supply into the reformer-reformate burner arrangement can then be interrupted or reduced and the reformate is then, in a third step, directed unburned or partially unburned into the fuel cell or the fuel cell unit.

As described above the product mixture leaving the reformer in the start-up phase contains a considerable amount of gaseous water and incompletely converted hydro-carbons. The anti-condensation temperature of the product mixture leaving the reformer is essentially determined by the hydrocarbons in the fuel cell. The anti condensation temperature is in the range of 30° C., preferably 150° to 450° C. The anti-condensation temperature then essentially corresponds with the temperature-specific boiling point of the fuel. The temperature-specific boiling point of the fuel is essentially determined by the fuel composition. For example, the boiling point for fuels having a high content of cyclic hydrocarbons is higher than for fuels having a low content of cyclic hydrocarbons.

In the third step, the hydrogenous unburned reformate flows through the fuel cell as described above, since the fuel cell has not yet reached the operating temperature at which electrical energy is produced through the reaction of the hydrogen and oxygen contained in the reformate. In this phase the unburned hydrogenous gas serves as a heat flow or carrier flow, which continues to heat the fuel cell on the fuel gas side of the fuel cell, or in other words on the anode side. After the unused reformate has flowed through the anode side of the fuel cell it is furnished to a residual gas burner. With the assistance of the residual gas burner, located downstream from the fuel cell, and the atmospheric oxygen, which is supplied on the cathode side of the fuel cell, the reformate is ignited and burned. With the assistance of the residual gas burner-heat exchanger the created combustion gas is used to heat the fuel cell also on the cathode side with air acting as carrier flow for heat.

In an alternative embodiment of the present invention a so-called mix-operation is run whereby the reformate is converted in the reformer-reformate burner arrangement with an air ratio of less than 1 and where the residual gas burner burns the residue of the burnable reformate.

When the fuel cell has reached its working or operating temperature which, depending on the fuel cell type, is in the range of between 50° and 1000° Celsius, then the hydrogen and the carbon monoxide of the reformate and the oxygen, which is supplied to the fuel cell on its cathode side, is converted without prior burning into electrical energy in a fourth process step.

In an especially preferred embodiment of the present invention an additional heat exchanger arrangement is located following the described residual burner arrangement with the heat transfer unit, for the purpose of transferring combustion heat, which is generated in the residual gas burner arrangement, to a heat transfer medium. In one variation of the fuel cell system, where an additional heat exchanger is located following the residual gas burner arrangement, the additional heat exchanger may, as described for example in German Patent DE 102 44 833 B4, be used to heat various vehicle system areas, for example a heating system.

In accordance with another embodiment of the present invention it is especially preferred if the fuel cell system includes a recirculation line to return the fuel cell exhaust gas, especially anode exhaust gas in systems which are equipped with high temperature fuel cells and cathode exhaust gas in systems which are equipped with PEM fuel cells. The recirculation line may be utilized on its own or together with a reformer-reformate burner arrangement in a fuel cell system.

In addition, changeover devices can be provided in the fuel cell system to connect the additional heat exchanger, which is located downstream from the residual gas burner arrangement, with an exhaust system of the fuel cell system or with a heating system for the purpose of transferring the heat flow, which is produced in the heat exchanger.

In the starting phase during which the combustion gases of the reformer-reformate burner arrangement are used to heat the components of the fuel cell system, the combustion gases are again brought to the infeed side of the reformer, preferably with a recirculation line, in order to support warming up of the reformer.

In addition to the previously described fuel cell system, the present invention also includes a method for starting a fuel cell system, as well as controls for starting a fuel cell system.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic longitudinal view of an embodiment of a reformer-reformate burner arrangement of the present invention;

FIG. 2A is a cross sectional view of the heating system depicted in FIG. 1, in the area of the reformer-reformate burner arrangement along with an embodiment of an air injection system of the present invention;

FIG. 2B is a cross sectional view of the heating system depicted in FIG. 1 in the area of the reformer-reformate burner arrangement with another embodiment of an air injection system;

FIG. 2C is a cross sectional view of the heating system depicted in FIG. 1 in the area of the reformer-reformate burner arrangement with still another embodiment of an air injection system;

FIG. 2D is a cross sectional view of the heating system depicted in FIG. 1 in the area of the reformer-reformate burner arrangement with yet another embodiment of an air injection system;

FIG. 3 is a block diagram of an embodiment of the fuel cell system including a high temperature fuel cell, a reformer, a reformer-reformate burner arrangement, a fuel cell and a residual gas burner arrangement; and

FIG. 4 is a block diagram of an embodiment of the fuel cell system including a protogenic low temperature fuel cell, reformer, a reformer-reformate arrangement, a fuel cell and a residual gas burner arrangement.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

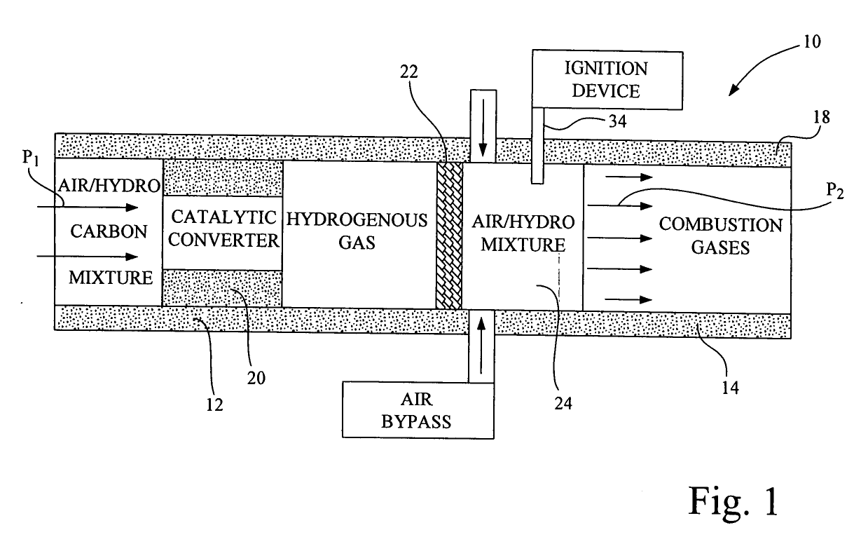

Referring now to the drawings, and, more particularly to FIG. 1 a reformer or reformer arrangement is shown including a reformer-reformate burner arrangement identified as 10. This system is organized into two zones, one reformer arrangement 12 located upstream and one following downstream reformate burner arrangement 14. In one embodiment of the present invention which is preferred due to its simple construction, all of these system zones 12 and 14 can be housed in a single tubular housing area 18. The reformer-reformate burner arrangement may also be housed in a tapered cross section of tubular housing section 18.

Reformer arrangement 12 includes a symbolically depicted catalytic converter 20 in which an air and hydrocarbon mixture is introduced which is symbolized by arrow P1. The mixture may be, diesel fuel, possibly with the addition of water (or a recycled product) or a pure water/hydrocarbon mixture so that the reformer arrangement 12 leaves behind a gaseous mixture, which contains a comparatively high content of hydrogen. For the production of the mixture, which is to be broken down, the reformer arrangement 12 may include an evaporator arrangement, which can be pre-heated or to which already pre-heated raw material, for the production of the mixture, can be supplied. Catalytic converter 20, as well as the air can be pre-heated electrically. A heating device, which provides the temperature necessary for catalysis, is allocated to catalytic converter 20. When using diesel fuel as a hydrocarbon, this temperature is in the range of 320° Celsius. Alternatively, pre-heating of the catalytic converter can also be achieved with the assistance of a thermal heat impulse of a flame. The flame can be provided through self-ignition of the air/hydrocarbon mixture, which is supplied to mixing chamber 13 of the reformer, when a sufficiently high temperature prevails in the mixing chamber. Otherwise, the air/hydrocarbon mixture can be ignited with the assistance of an ignition device.

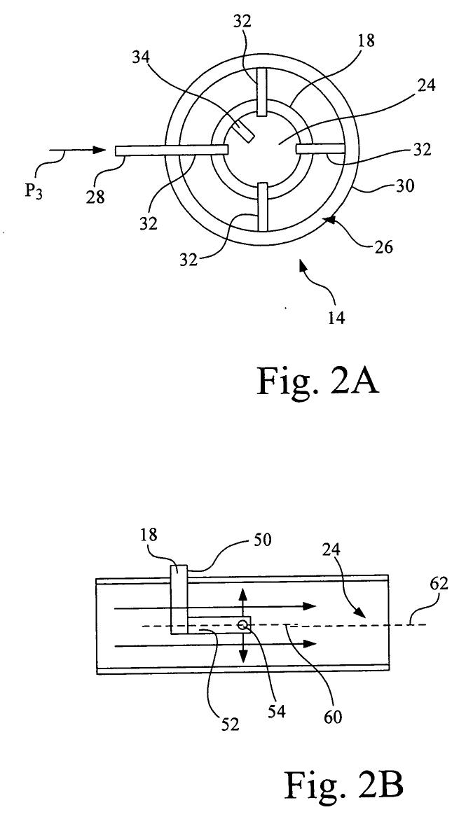

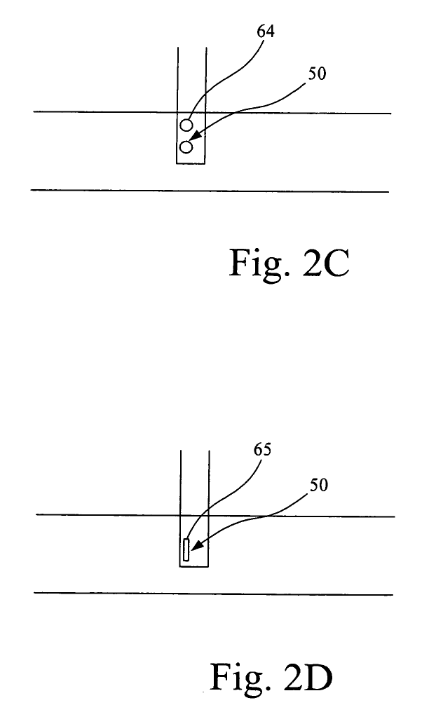

The gas leaving reformer arrangement 12 enters burner arrangement 14 or a combustion chamber 24 of burner arrangement 14 by way of a flame arrester 22. With the help of an air conveying unit, combustion air is fed into combustion chamber 24 through an air supply line system 26, depicted in FIGS. 2A through 2D. Flame arrester 22 is not required if the flow speed of the aqueous gas is greater than the return flow speed or flame speed of the air/hydrogen mixture.

Now additionally referring to FIG. 2A there is illustrated an embodiment of an air supply line system 26. In air supply line system 26 according to FIG. 2A air is supplied along arrow P₃ from the outside by way of line 28 of an air conveying unit to a ring-shaped distribution line 30. The air is then brought either through a multitude of air injection segments 32 into combustion chamber 24 or by way of openings in tubular housing area 18 and a ring channel 30 connected to line 28. Through special air control devices the air can also be provided with a twist when flowing into tubular housing area 18. A largely uniform infeed of the air that is to be burned together with the hydrogen that is fed into combustion chamber 24 is achieved. An ignition device 34 can be provided, such as a spiral wound filament, a glow plug or similar device, in order to ignite the air and hydrogen mixture and thereby initiate combustion. It is perhaps also possible to bring about a self-ignition at hot flame arrester 22 of the reformer-reformate burner.

In another embodiment of the present invention an air supply line system is illustrated in FIG. 2B. In this embodiment the supply of the air occurs through an air pipe 50 that is installed in burner chamber 24 of the reformer-reformate burner arrangement. The same components, as those of FIG. 2A are identified with the same reference numbers.

According to FIG. 2B air is supplied by way of line area 28 of an air conveying unit into a distributor pipe 52, which is run inside of combustion chamber 24. Distributor pipe 52 is equipped with openings 54 on its circumferential wall from which the air can flow out and into the combustion chamber. The opening can, for example, be perforated or slotted. The distributor pipe is preferably positioned symmetrically around an axis 60. In one example, axis 60 is positioned essentially parallel to axis 62 of combustion chamber 24, which is also tubular. Instead of the injection of air through distribution pipe 52, openings can be placed directly in air pipe 50. This configuration is illustrated in FIGS. 2C and 2D. FIG. 2C illustrates perforated openings 64 and FIG. 2D illustrates slotted openings 65. The air supply can of course also be distributed over a multitude of air pipes leading into the reformate combustion arrangement.

The products of combustion produced by the combustion in reformer-reformate arrangement 14 are generally in gaseous form and transport the heat that is created during combustion in the direction of the fuel cell. The components of the fuel cell system are heated by the heat which is transported by the combustion gases. Arrows P₂ indicate that the products of combustion or combustion exhaust gases exit the reformer-reformate burner arrangement and are further utilized as described below.

The system illustrated in FIGS. 1 and 2A-2D provides that the hydrogen gas that was produced in a reformer arrangement 12 can be used as fuel, for example, in order to heat the fuel cell unit itself to a suitable temperature in the start-up phase of the fuel cell system. As soon as a temperature is reached in the fuel cell whereby condensation no longer occurs in the product mixture, or in other words the reformate leaving the reformer arrangement that remains unburnt can be fed to the fuel cell. The reformate then continues to heat the anode side of the fuel cell. Through burning in a residual gas burner arrangement of the reformate, which was led through the fuel cell on the anode side and air on the cathode side, the cathode side of the fuel cell can continue to be heated.

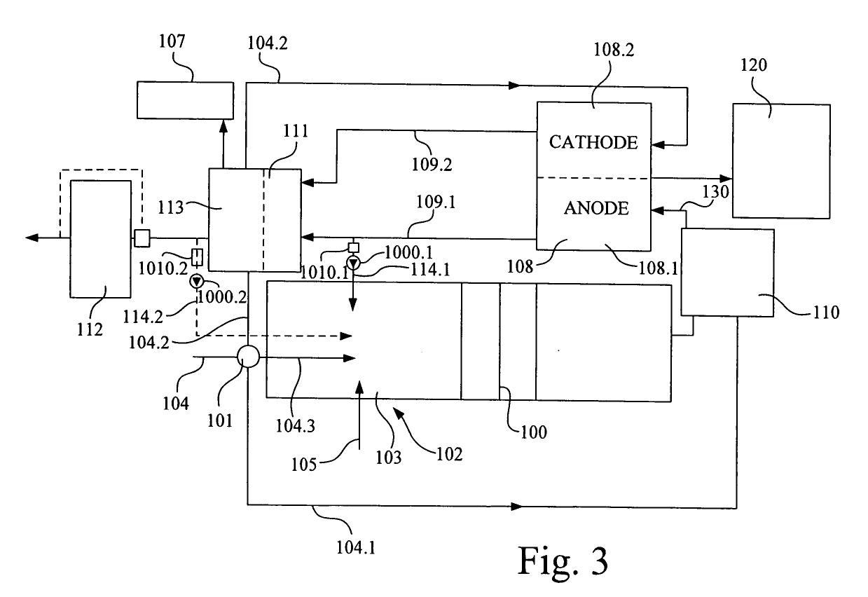

FIG. 3 illustrates the entire fuel cell system including a high temperature fuel cell. The reformer is identified with 102 in FIG. 3.

In another embodiment of the present invention, catalytic converter 100 or the air is heated by way of a non-depicted electrical heating device. Catalytic converter 100 of reformer 102 is heated to the catalytic converter activation temperature with this method. Heating could alternatively occur with the assistance of a flame. For this purpose an air-/hydrocarbon mixture which was fed into mixing chamber 103 can be ignited. Air is supplied to the mixing chamber through feed line 104; the hydrocarbon fuel is supplied through feed line 105. Feed line 104 for the air supply for mixing chamber 103 is branched at junction 101 into a supply line 104.1 for air into reformer-reformate burner 110, into a supply line 104.2 for air which leads to the cathode side 108.2 of the fuel cell and into a supply line 104.3 which branches off into the reformer. Supply line 104.3 can be pre-heated through a non-depicted integrated reformer-heat exchanger. In addition it can cool the catalytic converter through heat elimination. Instead of a common air supply through junction 101, individual air supply lines and air conveying units could also be provided to the individual components.

The ignited mixture forms a flame, which will heat catalytic converter 100 to the catalytic converter activation temperature. As soon as the activation temperature of the catalytic converter is reached, an aqueous gas, or the so-called reformate, is produced by supplying air and hydrocarbon to reformer 102. In the starting phase the reformate receives a considerable amount of gaseous water and incompletely converted hydrocarbons, which can condense out in the subsequent components of the system, for example, in fuel cell 108. In the present example the fuel cell is a high temperature fuel cell, which operates at an operating temperature of 650 to 900° Celsius. Chemical energy is converted into electrical energy at the operating temperature of 650° Celsius to 900° Celsius when providing air and/or atmospheric oxygen and/or O₂ through line 104.2 on the cathode side and reformate, or in other words, fuel gas, for example, H₂+CO through line 130 on the anode side. The high temperature fuel cell is preferably a solid oxide fuel cell (SOFC). Fuel cells of this type are known from a multitude of publications, for example from German Patent DE 19943523AI. In an SOFC fuel cell a solid ceramic electrolyte is used as electrolyte, H₂ and CO is used as fuel and atmospheric oxygen is used as an oxidative medium. The anode side, where the fuel gas, in this instance predominantly the fuel H₂ and CO is supplied from the direction of the reformer is identified with 108.1. The cathode side, on which the atmospheric oxygen is supplied, is identified with 108.2.

In order to avoid condensing out the reformate leaving the reformer is burned in the starting phase in the reformer-reformate burner arrangement 110, which is located following reformer 102. This causes warm combustion gases. These warm combustion gases are led from the reformer-reformate burner arrangement 110 into the fuel cell and serve to heat all transfers to fuel cell 108, as well as fuel cell 108 itself.

As soon as the anti-condensation temperature has been reached, which can be sensed through a temperature sensor reformer-reformate burner 110 can be shut off completely and the reformate, which was produced in the reformer, can be fed unburned into fuel cell 108. In another embodiment it is also possible to not shut off the reformer-reformate burner completely after reaching the anti-condensation temperature, but to let it run. In this instance the air flow is separated to a certain ratio at the changeover valve and a first part of the air is directed to the cathode side of the fuel cell and a second part of the air is directed to the reformer-reformate burner. Now only a part of the combustion gas from the reformer of the reformer-reformate burner is burned, while the other part gets admitted to the anode side of the fuel cell and serves there as fuel gas. This process is also described as a mixing operation. Attention needs to be given so that the critical re-oxidation temperature is not exceeded.

After reaching the anti-condensation temperatures not only the combustion gases alone, but also the reformate serve partially or completely, as a carrier flow for the heat. The carrier flow heat heats the lines as well as fuel cell 108 on anode side 108.1. The unburned hydrogenous gas is fed to the residual gas burner 111 through line 109.1. The unburned hydrogenous gas is burned together with the atmospheric oxygen in residual burner 111 with heat transfer unit 113. With the assistance of heat transfer unit 113 of the residual gas burner heat 107 generated by the combustion is used to heat the fuel cell on cathode side 108.2. Cathode side 108.2 of the fuel cell is supplied with air through line 104.2. The exhaust gas is directed through a second line 109.2 to residual gas burner 111. As illustrated, an additional heat transfer unit 112, for example a heat exchanger, is provided downstream from residual gas burner 111. With the help of second heat transfer unit 112 heat can be transferred to other parts of the vehicle system, for example to the heating system. The temperature on anode side 109.1 of the fuel cell can be detected with a temperature sensor, and the temperature on the cathode side can be detected with an additional fuel sensor. The temperature signals provided by the sensors are transferred to a control unit, which will turn off the reformer-reformate burner when reaching the anti-condensation temperature or will adjust a partial flow at the changeover valve, in other words transition into the mixing operation.

When the fuel cell has reached the operating temperature, which is preferably between 600° and 1000° Celsius, more especially preferably between 650° and 900’0 Celsius the hydrogenous reformate that is supplied on anode side 104.1 is converted into electrical energy by a chemical energy and is furnished to an electrical sink 120. The hydrogen that is still present in the residual gas in this condition, that is the operating condition of the fuel cell, can either be burned in the residual gas burner 111 or alternatively can be supplied to the reformer 102 through a recirculation line. Recirculation line 114.1, located before residual gas burner 111, directs unburned hydrogenous residual gas from the burner arrangement into mixture formation chamber 103. Alternatively, recirculation line 114.2 can branch off after the residual gas burner and can deliver residual gas from the residual gas burner arrangement with the help of a gas conveying unit to mixture formation chamber 103. The return or recirculation of the entire or even partial volume of the reformate, which was largely converted in the fuel cell, enables the temperature in the reformer to be reduced, thereby increasing the life span of the reformer. This is due to the fact that the water components in the returned reformate flow react with the hydrocarbon of the fuel, thereby increasing the hydrogen yield and thereby the overall efficiency of the system. Since the reaction of the water components is an endothermic reaction the temperature in the catalytic converter is reduced, thereby increasing its lifespan. A sufficient volume of water components in the anode exhaust gas is present at sufficient conversion of hydrogen in the fuel cell, in other words during the operating phase of the fuel cell, when electricity is generated. In a high temperature fuel cell the anode exhaust gas is transported directly into the mixture formation chamber 103 from the low pressure area of the system after fuel cell 108 by way of a transportation unit 1000.1 through a recirculation line 114.1. Possible conveying devices 1000.1 may be in the embodiment of blowers, condensers, compressors or water jet pumps. In the illustrated example an additional recirculation line 114.2 is provided, which brings exhaust gas from residual gas burner 111 before reformer 102. The water content in the residual burner exhaust gas is generally lower than that in the anode exhaust gas. This is the reason that recirculation line 114.1 is preferred as opposed to recirculation line 114.2. Transportation device 1000.2 may again be in the embodiment of a housing, condenser, compressor or a water jet pump.

In addition to the advantages during the operating phase, a return of anode exhaust gas also has advantages during the start phase as reformate of the fuel cell system. A mixture formation temperature, and thereby the catalytic converter inlet temperature, can be reduced through the returned predominantly nitrogenous gas. Since the anode exhaust gas has a high temperature during operation the fuel cell exhaust gas, which generally has a temperature of up to 850° C. can be cooled in recirculation line 114.1 and 114.2 by way of a cooling device 1010.1 or 1010.2, in order to protect the transportation device from damage.

The heat generated in residual gas burner 111 is used in the operating condition of residual gas burner 111 to pre-heat reactants, for example, the cathode air of fuel cell 108, as illustrated in the schematic diagram.

The power generated at operating temperature in fuel cell 108 is delivered to an electrical sink 120 during operating condition of fuel cell 102, as indicated in the schematic diagram.

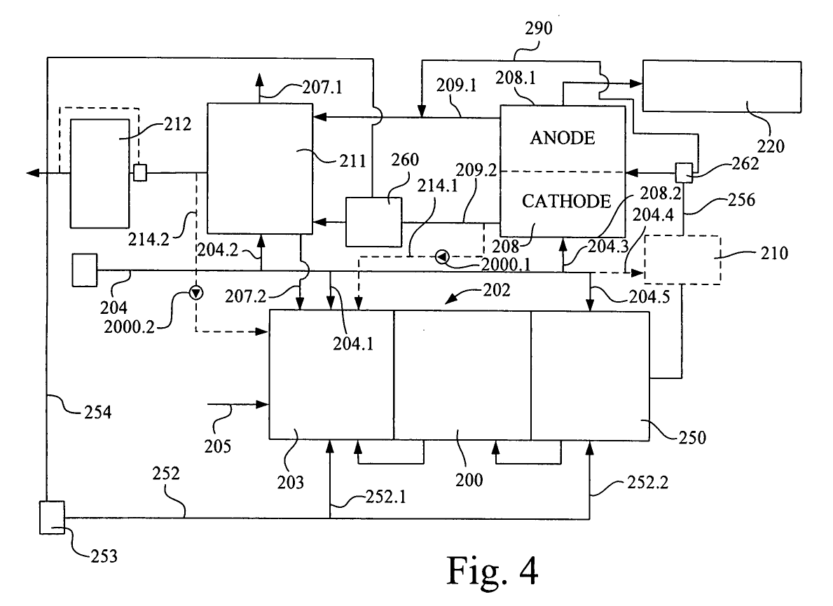

Now additionally referring to FIG. 4 there is illustrated another embodiment of the present invention. This uses a so-called proton exchange membrane fuel cell (PEM) or in other words a membrane fuel cell in place of a high temperature fuel cell. In contrast to the high temperature fuel cell, a PEM fuel cell operates at an operating temperature in the range of 50° Celsius to 150° Celsius, ideally even at minus temperatures. A PEM fuel cell employs a perfluorated sulfonated polymeric electrolyte as an electrolyte and either hydrogen or a reformed hydrogen as fuel and oxygen or atmospheric oxygen as an oxidation medium. Besides the temperature the difference between the high temperature fuel cell depicted in FIG. 3 and the PEM fuel cell depicted in FIG. 4 is the opposite transportation direction of hydrogen and oxygen ions. In the case of the high temperature fuel cell H₂O, in other words, water or water-containing exhaust gas, is produced on the anode side and in the case of the PEFC fuel cells on the cathode side. Identical components in the diagram according to FIG. 4 are identified with the same reference numbers, however increased by 100.

Reference number 204 identifies the system's air supply line. The air supply line delivers air through line 204.1 into mixture formation chamber 203 of reformer 202, as well as through line 204.2 into residual gas burner 211, through line 204.3 to cathode side 208.2 of fuel cell 208 and through line 204.5 into heat exchanger step 250 of the gas cleaner. In the embodiment of the invention illustrated in FIG. 4, reformer-reformate burner arrangement 210 can be connected between reformer 202 and gas cleaning step 250 (not shown) or the anode side of fuel cell 208.1. If a reformer-reformate burner arrangement 210 is provided, then air is supplied to the arrangement by way of line 204.4.

However, due to the low operating temperature of fuel cell of only 80 to 150° Celsius, the reformer-reformate burner arrangement can be omitted. Since the reformer-reformate burner arrangement in the embodiment depicted in FIG. 4 is only optional it is indicated by broken lines in the diagram. The fuel is delivered to mixture formation chamber 203 of reformer 202 through line 205. The system also includes a water pipe system 252. With the help of water pipe system 252 water can be delivered through line 252.1 into mixture formation chamber 203 and through line 252.2 into the heat exchanger (not shown) of gas cleaning step 250 and the heat exchanger (not shown) of reformer 202 or into the heat exchanger (not shown) of residual gas burner 211, in order to maintain the operating ranges of the catalytic converters based on the exothermal reaction and to overheat and evaporate the water.

The embodiment of the present invention illustrated in FIG. 4 also provides a water recovery step 260 downstream from fuel cell 208. This serves to recover water from the hydrogenous residual gas leaving cathode side 208.2 of fuel cell 208 and to return it through line 254 to water removal line 252. The water is collected in water tank 253.

As already described, the provision of hydrogenous gas as fuel for the fuel cell occurs in reformer 202. The reformer includes a mixture formation chamber 203 into which a hydrocarbon/air mixture is fed and is converted to a hydrogenous reformate with the help of a catalytic converter 200. The operating temperature of the catalytic converter is approximately 900 to 1000° Celsius, preferably 950° Celsius. Heating of the catalytic converter to the catalytic converter activation temperature can occur with the help of electric pre-heating or a flame, as described previously. Downstream from the catalytic converter is a gas cleaning step 250 which essentially cleans the combustion gas of CO. The gas cleaning step is required with the low temperature fuel cell, since the low temperature fuel cell only tolerates impurities of 50 ppm maximum. At contents of higher than 50 ppm CO the CO condenses out on the active layer of the fuel cell and thereby prevents a diffusion of H⁺-ions. In addition, a bypass line 290 can be provided with which the CO-containing fuel gas is routed past the anode side 208.1 of the fuel cell and directed into residual gas line 209.1. A changeover valve 262 is provided for changeover of the bypass line. An arrangement of this type is advantageous in the start-up phase when the temperature for a complete conversion of CO in the gas cleaning stage has not yet been reached. The optional reformate-residual gas burner 210 is preferably located before gas cleaning step 250.

In order to avoid condensing out of the residual hydrocarbons contained in the reformate, which can lead to irreversible residues in the fuel cells a reformer-reformate burner arrangement 210 is provided in one embodiment between reformer 202 and gas cleaning step 250 or in an alternative embodiment between gas cleaning step 250 and anode side 208.1 of the fuel cell, as in the aforementioned embodiment. The embodiment including a reformer-reformate burner is optional and in no way essential. In order to avoid a direct admission of combustion gas to the anode side of the fuel cell, especially during start-up of the system, when the CO content is at its highest and which can lead to a contamination with carbon monoxide, a changeover valve 262 is provided before the fuel cell and also a bypass line 290. Changeover valve 262 directs the gas into the bypass line, especially during the start, in order to direct fuel gas with too high a CO content into the exhaust gas system of the fuel cell system.

Once the operating temperature of PEM-fuel cell 208, which is preferably between 50 and 150° Celsius, especially between 80 and 150° Celsius has been reached the hydrogenous fuel gas, which is supplied to the cathode side of the fuel cell through line 256 reacts with atmospheric oxygen 204.3, which is admitted on cathode side 208.2, so that an electric energy is produced which can be provided to an electrical sink 220.

The hydrogenous residual gas accumulating in the fuel cell as well as the spent air are fed through lines 209.1 (hydrogenous residual gas) and 209.2 (spent air) to residual burner 211 and can be burned there. The thereby produced heat is indicated by arrows 207.1 and 207.2. This heat can be released or supplied to the reformer in order to heat it. A heat exchanger 212 can be provided downstream from residual gas burner 211 where the heat provided by the residual gas burner can be used to heat the reactants air and/or water, or other vehicle areas.

According to FIG. 3, recirculation lines 214.1 and 214.2 are provided whereby in the embodiment of FIG. 4, with a PEM fuel cell, the hydrogenous cathode exhaust gas is re-circulated instead of the anode exhaust gas. The return or recirculation of the entire or even partial volume of the reformate, which was largely converted in the fuel cell enables the temperature in the reformer to be reduced, thereby increasing the life span of the reformer. This is due to the fact that the water components in the recirculated reformate flow react with the hydrocarbon of the fuel, thereby increasing the hydrogen yield and thereby the overall efficiency of the system. Since the reaction of the water components is an endothermic reaction the temperature in the catalytic converter is reduced, thereby increasing its lifespan. A sufficient volume of water components in the cathode exhaust gas is present at sufficient levels for the conversion of hydrogen in the fuel cell, in other words, during the operating phase of the fuel cell, when electricity is generated. The cathode exhaust gas is transported directly into mixture formation chamber 203 from the low pressure area of the system after fuel cell 208 by way of a transportation unit 2000.1 through a recirculation line 214.1. Possible transportation devices 2000.1 may be in the embodiment of blowers, condensers, compressors or water jet pumps. An additional recirculation line 214.2 is provided, which brings gas from residual gas burner 211 before reformer 202. The water content in the residual burner exhaust gas is generally lower than that in the cathode exhaust gas. This is the reason that recirculation line 214.1 is preferred as opposed to recirculation line 214.2. Transportation device 2000.2 may again be in the embodiment of a housing, condenser, compressor or a water jet pump.

In addition to the advantages during the operating phase, a return of cathode exhaust gas also has advantages during the start phase as reformate of the fuel cell system. Inerting in the mixture formation temperature can be created through the returned predominantly nitrogenous gas and thereby a reduction in the catalytic converter inlet temperature.

In contrast to the exhaust gases from the high temperature fuel cell, the exhaust temperature of the cathode gases is only 80° C. to 160° C. Cooling therefore is not advantageous, since it would lead to condensing out of water in this instance.

The embodiment illustrated in FIG. 4 differentiates itself from the embodiment illustrated in FIG. 3 essentially through the choice of the type of fuel cell.

The present invention includes a fuel cell system, which provides a reformer-reformate burner arrangement as well as a residual gas burner arrangement and whereby start-up of the fuel cell system occurs with the help of the reformer-reformate burner arrangement and the residual gas burner arrangement.

Due to the utilization of a reformer-reformate burner arrangement the residual hydro-carbons, which are contained during the starting phase in the reformate can be burned in order to thereby avoid irreversible residues in the fuel cell. On the basis of this method process it is possible to heat the fuel cell system directly with gases as a heat source without a heat exchanger having to be installed in an in-line arrangement.

A very efficient and quick start of the fuel cell arrangement is achieved based on that the reformer-reformate burner arrangement is turned off as soon as the anti-condensation temperature is reached and that the unused reformate can be used as a heat source to heat the fuel cell. An in-line installation of a separate heat exchanger is no longer necessary. An additional advantage of the system is the very quick start of the fuel cell system which, among other factors is due to the flame having less power in the mixture formation than the flame in the reformer-reformate burner.

The present invention also shows, for the first time, fuel cell systems whereby aqueous fuel cell exhaust gas is routed back to the reformer, especially into the mixture formation chamber through a recirculation line or through several recirculation lines.

Specifically, the cathode gas is returned with PEM fuel cells and the anode gas is recycled with high temperature fuel cells.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A fuel cell system for a vehicle, comprising:
at least one reformer configured for the production of a reformate as a fuel gas;
at least one fuel cell to which the reformate from said at least one reformer is supplied;
at least one reformer-reformate burner arrangement, said at least one reformer-reformate burner arrangement being connected to said fuel cell, immediately directing into said at least one fuel cell one of the reformate after reaching an anti-condensation temperature and residual hydrocarbons and water vapor which are produced in said at least one reformer-reformate burner arrangement prior to reaching an anti-condensation temperature.

2. The fuel cell system of claim 1, further comprising a residual gas burner arrangement downstream from said fuel cell.

3. The fuel cell system of claim 2, further comprising at least one heat exchanger includes a first heat exchanger that transfers combustion heat generated in said residual gas burner arrangement to a heat transfer medium.

4. The fuel cell system of claim 3, wherein said at least one heat exchanger includes a second heat exchanger following said residual gas burner arrangement.

5. The fuel cell system of claim 4, further comprising a changeover device connecting said second heat exchanger with a heating system.

6. The fuel cell system of claim 5, further comprising:
a combustion chamber; and
a flame arrester positioned between said at least one reformer and said combustion chamber.

7. The fuel cell system of claim 1, wherein said fuel cell is a high temperature fuel cell.

8. The fuel cell system of claim 1, wherein said fuel cell is a Proton Exchange Membrane (PEM) fuel cell.

9. The fuel cell system of claim 8, further comprising a gas cleaning step.

10. The fuel cell system of claim 9, wherein said at least one reformer-reformate burner arrangement is located one of between said at least one reformer and said gas cleaning step, and between said gas cleaning step and said fuel cell.

11. The fuel cell system of claim 1, wherein said at least one reformer-reformate burner arrangement includes a combustion chamber.

12. The fuel cell system of claim 1, wherein said at least one reformer-reformate burner arrangement includes an air injection system.

13. The fuel cell system of claim 1, wherein said at least one reformer-reformate burner arrangement includes a flame guard.

14. The fuel cell system of claim 1, wherein said at least one reformer-reformate burner arrangement includes an ignition device.

15. A fuel cell system for a vehicle, comprising:
at least one fuel cell having an input side and an output side;
at least one reformer for the production of a reformate as a fuel gas for said fuel cell, said at least one reformer including a mixture formation chamber, said reformate being supplied to said input side of said at least one fuel cell for the production of electrical energy; and
at least one recirculation line between said output side of said fuel cell and said mixture formation chamber.

16. The fuel cell system of claim 15, wherein said at least one fuel cell is a high temperature fuel cell, said recirculation line connecting an anode side of said high temperature fuel cell with said mixture formation chamber.

17. The fuel cell system of claim 16, further comprising a cooling unit connected to said at least one recirculation line.

18. The fuel cell system of claim 15, wherein said fuel cell is a PEM fuel cell and said at least one recirculation line connects a cathode side of said PEM fuel cell with said mixture formation chamber.

19. The fuel cell system of claim 15, further comprising a transportation unit provided in said at least one recirculation line.

20. The fuel cell system of claim 19, wherein said transportation unit is at least one of a blower, a condenser, a compressor and a water jet pump.

21. The fuel cell system of claim 15, further comprising a reformer-reformate burner arrangement connected with said at least one fuel cell, whereby prior to reaching an anti-condensation temperature of residual hydrocarbon and water vapor the combustion gases produced in said reformer-reformate burner arrangement or alternatively after reaching the condensation temperature reformate is directed into the fuel cell.

22. A method for starting a fuel cell system, the fuel cell system including a reformer, a reformer-reformate burner arrangement and at least one fuel cell, the method comprising the steps of:
starting the reformer one of electrically or thermally at an air ratio greater than 1;
heating a catalytic converter of the reformer to a catalytic converter activation temperature;
producing a reformate in the reformer after reaching said catalytic converter activation temperature at an air ratio less than 1, said reformate is then burned in the reformer-reformate burner arrangement at an air ratio greater than 1, whereby combustion gases are created;
feeding said combustion gases to the fuel cell;
interrupting the burning of the reformate in the reformer-reformate burner arrangement after reaching an anti-condensation temperature;
feeding unburned reformate to the fuel cell and to a residual gas burner; and
using said residual gas burner to burn the unburned component of anode exhaust gas at an air ratio greater than 1 and by way of a heat exchanger heat the air and/or water to heat the fuel cell to an operating temperature or the reactants air and/or water for the reformer.

23. A method for starting a fuel cell system, the fuel cell system including a reformer, a reformer-reformate burner arrangement and at least one fuel cell, the method comprising the steps of:
starting the reformer one of electrically or thermally at an air ratio greater than 1;
heating a catalytic converter of the reformer to a catalytic converter activation temperature;
producing a reformate in the reformer after reaching said catalytic converter activation temperature at an air ratio less than 1, said reformate is then burned in the reformer-reformate burner arrangement at an air ratio greater than 1, whereby combustion gases are created, a portion of said reformate not being burned and leaves the reformer-reformate burner unburned.
feeding said combustion gases to the fuel cell;
after reaching an anti-condensation temperature the burning of said reformate in the reformer-reformate burner arrangement is either interrupted and the reformat is returned to the fuel cell unburned and to a residual gas burner or the reformate is burned only partially in the reformer-reformate burner arrangement and unburned reformate and combustion exhaust gases are fed to the fuel cell and a residual gas burner; and
using the residual gas burner to burn the unburned component of the anode gas at an air ratio greater than 1 and through a heat exchanger heat the air and/or water, in order to heat the fuel cell to an operating temperature.

24. The method of claim 23, wherein said anti-condensation temperature is in a range of from 150° to 450° Celsius.

25. The method of claim 23, wherein an operating temperature of a high temperature fuel cell unit is in the range of from 550° to 1000° Celsius.

26. A method for reducing the temperature in a reformer arrangement, comprising the steps of:
prior to reaching an operating temperature of a fuel cell nitrogenous fuel cell exhaust gas is directed into a mixture formation chamber; and
after reaching the operating temperature of the fuel cell nitrogenous and aqueous fuel cell exhaust gas is directed into the mixture formation chamber.
